(19) United States
(12) Patent Application Publication
(10) Pub. No.: US 2010/0094713 A1
(43) Pub. Date: Apr. 15, 2010

(54) ADVERTISEMENT CONTENT GENERATION AND MONETIZATION PLATFORM

(76) Inventor: Brian K. Wax, Lake Forest, IL (US)

Correspondence Address: DESIGN IP, P.C., 5100 W. TILGHMAN STREET, SUITE 205, ALLENTOWN, PA, 18104, US

(21) Appl. No.: 12/527,102

(22) PCT Filed: Feb. 15, 2008
(86) PCT No.: PCT/US2008/054066

§ 371 Date: Oct. 21, 2009

Related U.S. Application Data
(60) Provisional application No. 60/901,555, filed on Feb. 15, 2007.

(51) Int. Cl. G06Q 30/00

(52) U.S. Cl. 705/14.69

(57) ABSTRACT

System and methods are provided for the generation and monetization of advertisement content. In an illustrative implementation, a computing environment comprises an advertisement content generation and monetization engine, a data store, and an instruction set comprising one or more instructions to instruct the advertisement content generation and monetization engine to allow participating users to generate advertisement content according to a selected user-generated content paradigm and to allow participating users to monetize the user-generated advertisement content according to one or more selected monetization paradigms. In an illustrative operation, a participating user interacts with the advertisement content generation and monetization engine to determine the advertisement content to be generated. In the illustrative operation, user-generated advertisement content can be communicated to the advertisement content generation and monetization engine for storage on the exemplary data store and for distribution to cooperating parties to allow for the monetization of the user generated advertisement content.

### CROSS REFERENCE TO RELATED APPLICATION(S)

This application is a submission under 35 U.S.C. § 371 of International Application No. PCT/U.S. 2008/054066, filed Feb. 15, 2008, which in turn claims priority from U.S. Provisional Application no. 60/901,555, filed Feb. 15, 2007, which are incorporated by reference as if fully set forth.

### BACKGROUND

The proliferation of computing networking and communications technologies has lead to the development of various applications and services that allow geographically disparate participating users to electronically communicate data and content—e.g., the Internet. The Internet is increasingly being used as a platform for the deployment of various services (e.g., in the form of applications) that allow disaggregated participating users having a common interest to become aggregated and to share one or more specific interests. Such services generally operate to establish “communities,” “groups,” or “social networks” in which users can search for other users having common interests or to allow users to have a platform to freely exchange content (e.g., audio, video, text, other digital media, etc.). Such services also result in the aggregation of resources among participating users that can be used by service operators to accomplish one or more selected task—e.g., product reviews, content aggregation—wiki services, content publishing, etc.

These services also have the effect of stratifying participating users according to other criteria beyond particular interest and affinity, including usage behavior and various socio-economic demographic categories such as age, race, geographic region, income, etc. In segmenting the pool of participating users, service operators can offer cooperating advertisers the ability to target specific sections of the universe of participating users (for a particular service or across a number of services).

With current practices, advertisers generally create content (i.e., professionally produced advertisement content) directed for distribution across the Internet. Such content can be part of larger advertising campaign and can contain the themes of such campaign. In such context, the campaign might consist of a television component, print component, and Internet advertising. Responsive to the demand by advertisers to distribute advertisement content across the Internet, a number of services/applications have been developed and deployed to allow advertisers to display and distribute their advertisement content across various cooperating websites on the Internet. Included in such services and applications are processes that allow for the reconciliation of payment from advertisers to advertiser brokers, website operators, and, in some instances to participating end-users.

By way of example, a number of Internet services exist to allow advertisers to place “banner” advertisements which advertisers pay such service operators a fee to place on various web sites. The intent being to place such banner advertisements on websites that attract participating users presenting a particular demographic. For example, a sports equipment manufacturer might engage advertisement agencies (or directly work with web site operators) to place Internet based advertisements on web sites having sports content. In such context, the sports manufacturer is relying on an assumption (and/or data proven correlation) that web sites having sports content will attract participating users who are more likely to purchase sports equipment. Even though such practice can have the effect of delivering advertisement content to intended participating users, such practice does not allow participating users to have control over the advertisement content to which the participating user is being asked to view and with which to interact.

Other advertisement services and operations deployed on communications networks (including, mobile data communication networks—e.g., mobile telephone/data networks, and television based communication networks—e.g., electronic advertisements found on electronic programming guides on various cable and satellite based television/data platforms) can include direct electronic advertisements such as e-mail, instant messaging, facsimile (electronic/traditional), short message services, blogs, and newsfeeds (RSS). These practices, akin to advertisement banners, do not operate to leverage the significant resources made available by the electronic communications networks—namely, the resources that can be provided by participating users in the form of user-generated advertisements. As such, advertisement content currently does not maximize and/or optimize particular relevance, interest, and effectiveness to users.

From the foregoing it is appreciated that there exists a need for a new platform that ameliorates the shortcomings of existing practices.

### SUMMARY

The herein described methods and systems provide a computer-implemented platform for the generation and monetization of advertisement content. In an illustrative implementation, a computing environment comprises an advertisement content generation and monetization engine, a data store, and an instruction set comprising one or more instructions to instruct the advertisement content generation and monetization engine to allow participating users to generate advertisement content according to a selected user-generated content paradigm and to allow participating users to monetize the user-generated advertisement content according to one or more selected monetization paradigms.

In an illustrative operation, a participating user interacts with the advertisement content generation and monetization engine to determine the advertisement content to be generated. In the illustrative operation, user-generated advertisement content can be communicated to the advertisement content generation and monetization engine for storage on the exemplary data store and for distribution to cooperating parties to allow for the monetization of the user generated advertisement content.

In the illustrative operation, user-generated advertisements are created by participating users that can comprise various types of advertisements (ads) including but not limited to ads with photo of a product and comments from the user, text ads where the user generates only his/her comments, video only ads, audio only ads, and ads having a combination of one or more of audio, video, and text. In the illustrative operation, an exemplary monetization paradigm can be employed that allows for the payment of a commission to the user who generated the advertisement when another user (i.e., who is not associated with the generation of the advertisement) interacts with the user-generated advertisement. In the exemplary monetization paradigm, such payment can comprise cash value, reward points having some cash/product value, and a combination of cash and reward points. In the illustrative operation, advertisers can provide guidelines for acceptable user-generated advertisements. Additionally, advertisers can cooperate with advertisement service operators to commission and pay for user-generated advertisements according to one or more advertisement programs.

Other features of the herein described systems and methods are further described below.

### BRIEF DESCRIPTION OF THE DRAWINGS

The methods and system for an advertisement content generation and monetization platform are further described with reference to the accompanying drawings in which:

FIG. 1 is a block diagram of an exemplary computing environment in accordance with an implementation of the herein described systems and methods;

FIG. 2 is a block diagram showing the cooperation of exemplary components of an illustrative implementation in a networked computing environment in accordance with the herein described systems and methods;

FIG. 3 is block diagram showing the cooperation of exemplary components of an exemplary advertisement content generation and monetization platform in accordance with the herein described systems and methods;

FIG. 4 is a block diagram showing, in more detail, the cooperation of exemplary components of an illustrative implementation of an advertisement content generation and monetization platform for retail transactions in accordance with the herein described systems and methods;

FIG. 5 is a flow diagram showing exemplary processing performed in generating advertisement content in accordance with the herein described systems and methods; and

FIG. 6 is a flow diagram showing exemplary processing performed when monetizing advertisement content in accordance with the herein described systems and methods.

### DETAILED DESCRIPTION

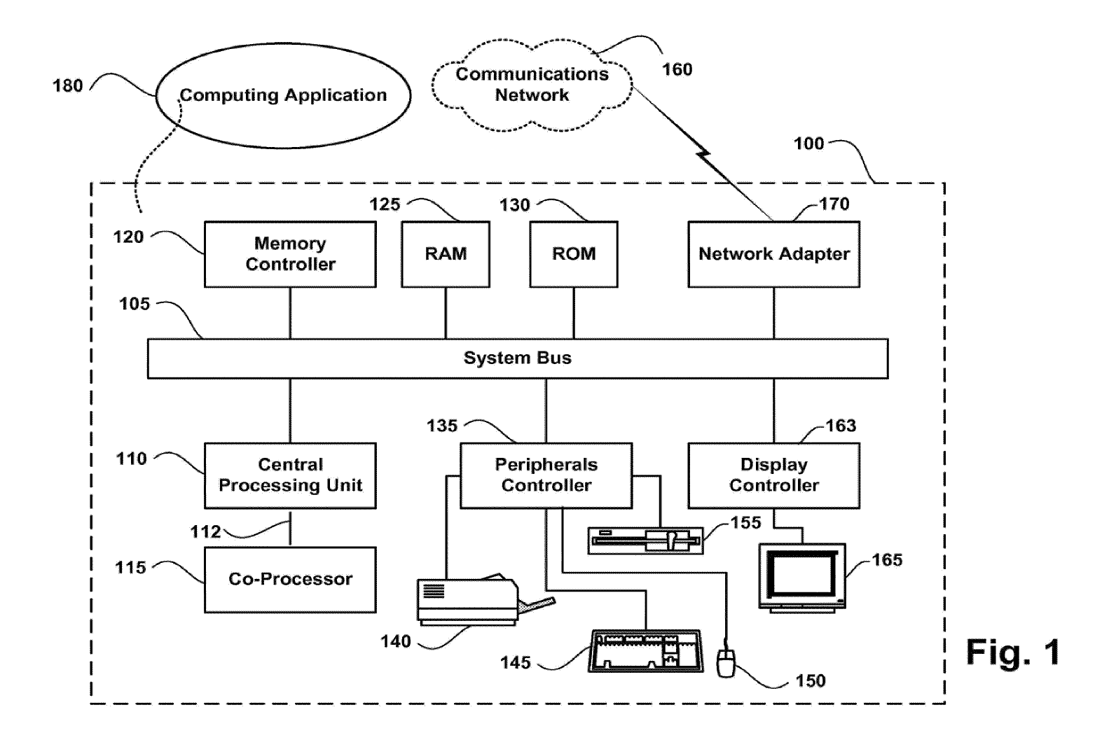

FIG. 1 depicts an exemplary computing system 100 in accordance with herein described system and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus 105 connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain a peripherals controller 135, which is responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to an external communication network 160.

Illustrative Computer Network Environment:

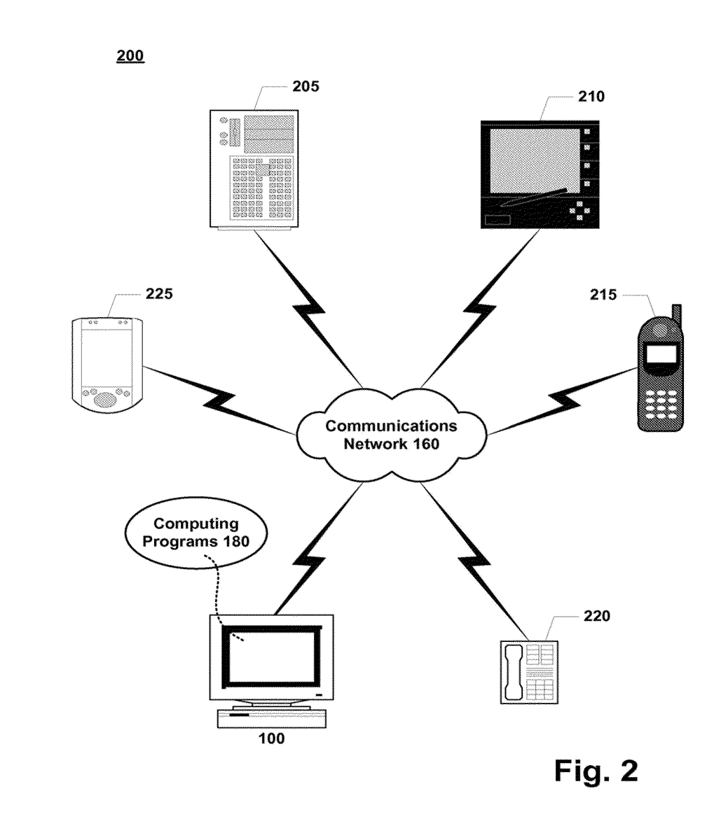

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, computing system 100 (a personal computer), and personal digital assistance 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environment to obtain desired data and/or computing applications. The data and/or computing applications may be stored on server computing environment 205 and communicated to participating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### Content Generation and Monetization

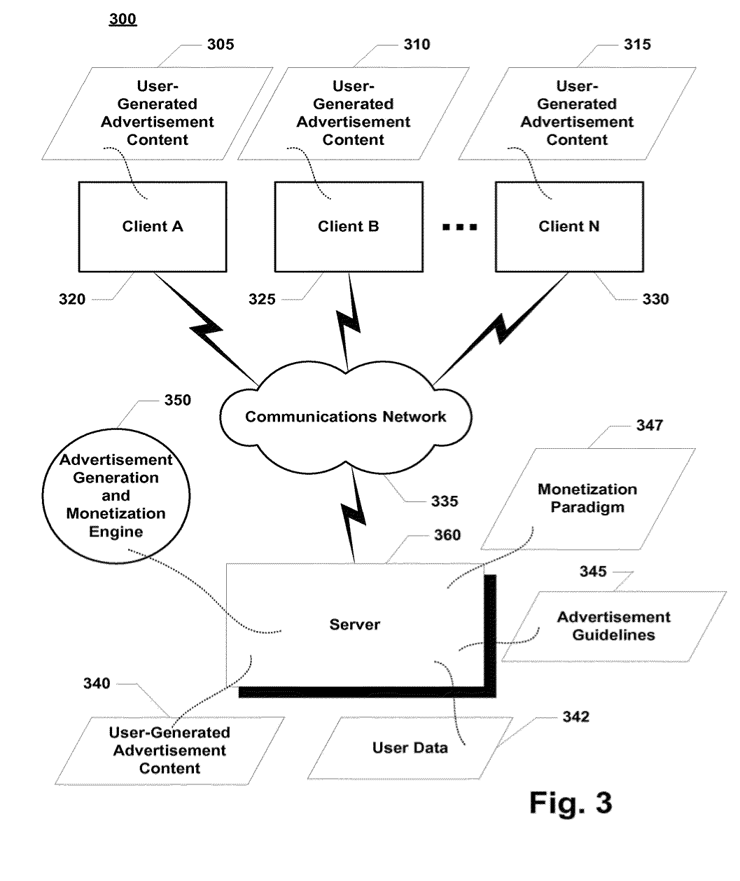

FIG. 3 shows an illustrative implementation of exemplary advertisement generation and monetization platform 300. As is shown in FIG. 3, exemplary advertisement generation and monetization platform 300 comprises client computing environment 320, client computing environment 325 up to and including client computing environment 330, communications network 335, server computing environment 360, advertisement generation and monetization 350, user-generated advertisement content 340, user data 342, advertisement guidelines 345, and monetization paradigm 347. Also, as is shown in FIG. 3, advertisement generation and monetization platform 300 can comprise a plurality of user-generated advertisement content 305, 310, and 315 which can be displayed, viewed, stored, electronically transmitted, and printed from client computing environments 320, 325, and 330, respectively.

In an illustrative operation, client computing environments 320, 325, and 330 can communicate and cooperate with server computing environment 360 over communications network 335 to provide requests for and receive user-generated advertisement content 305, 310, and 315. Illustratively, such requests can comprise requests to determine which user-generated advertisements are being commissioned (e.g., being commissioned by advertisers) and/or requests to place user-generated advertisements for distribution to advertisers and other cooperating parties.

In the illustrative operation, advertisement generation and monetization engine 350 can operate on server computing environment 360 to provide one or more instructions to server computing environment 360 to process requests for advertisement generation, monetization of existing user-generated advertisements, and/or already generated user-generated advertisements. In this instance, the request is to retrieve and interact with already generated user-generated advertisements, operative on such instructions from advertisement generation and monetization engine 350, server computing environment 360 can operate to electronically communicate such requests for user-generated advertisements 305, 310, and 315 to the requesting client computing environment (e.g., client computing environment 320, client computing environment 325, or client computing environment 335).

As part of processing requests for advertisement generation and/or monetization, advertisement generation and monetization engine 350 can utilize a plurality of data comprising user-generated advertisement content 340, user data 342, advertisement guidelines 345, and/or monetization paradigm data 347. Also, as is shown in FIG. 3, client computing environments 320, 325, and 330 are capable of processing user-generated advertisement content 305, 310, and 315 for display and interaction to one or more participating users (not shown).

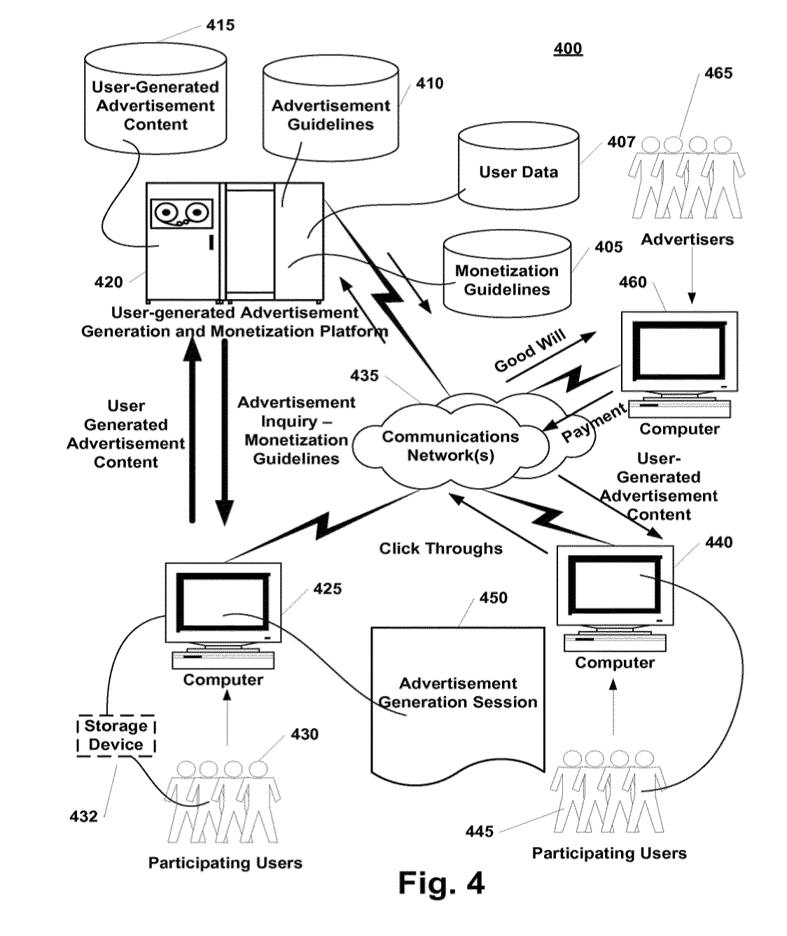

FIG. 4 shows a detailed illustrative implementation of a user-generated advertisement generation and monetization environment 400. As is shown in FIG. 4, exemplary advertisement generation and monetization environment 400 comprises user-generated advertisement generation and monetization platform 420, user-generated advertisement content data store 415, advertisement guidelines data store 410, monetization guidelines data store 405, and user data store 407, user computing environment 425, advertisement content sources (e.g., users) 430, other participating users computing environment 440, other participating users 445, advertisers computing environment 460, and advertisers 465. Additionally, as is shown in FIG. 4, advertisement generation and monetization environment 400 can comprise user-generated advertisement session content (e.g., live and/or stored) 450 which can be displayed, viewed, transmitted and/or printed from content source (e.g., user) computing environment 425, other participating users computing environment 440, and/or advertiser computing environment 460. Further as is shown, user computing environment 425 can cooperate with a storage device (e.g., memory storage device, mobile phone, MP3 device, MP4 device, video-camera, etc.) to source advertisement content for communication and processing with advertisement generation and monetization platform 420.

In an illustrative implementation, advertisement generation and monetization platform 420 can be electronically coupled to user computing environment 425, other participating users computing environment 440, and advertisers computing environment 460 via communications network 435. In the illustrative implementation, communications network can comprise fixed-wire and/or wireless intranets, extranets, and the Internet.

In an illustrative operation, users 430 can interact with advertisement generation and monetization interface (not shown) operating on user computing environment 425 to provide requests to initiate an advertisement generation and monetization session that are passed across communications network 435 to advertisement generation and monetization platform 420. In the illustrative operation, advertisement generation and monetization platform 420 can process requests for an advertisement generation and monetization session and cooperate with user-generated advertisement content data store 415, advertisement guidelines data store 410, monetization guidelines data store 405, and user data store 407 to generate an advertisement generation and monetization session for use by users 430, other participating users 445, and advertisers 465.

In an illustrative implementation, user-generated advertisement content data store 415 can comprise user-generated advertisement content and/or content portions generated by one or more users 430 for use by advertisers 465 to reach other participating users 445. Such user-generated advertisement content can include but is not limited to digital content including but not limited to (live and/or recorded), movies, spoken word, music, digital media works, artwork which can be viewed, purchased, and distributed by advertisers 465. In the illustrative implementation, advertisement guideline data store 410 can comprise data representative of one or more advertisement quality and content thresholds which are required to be satisfied by users 430 generating advertisements before advertisers 465 would be willing to purchase and distribute such user-generated advertisements. Monetization guidelines data store 405 can comprise one or more monetization paradigms (e.g., including one or more pricing models) which describe the manner, type, and timing of payment to users who generate advertisements for use by advertisers 465 (e.g., user gets paid a commission of $0.05 by the advertiser each time one or more other participating users click to see the given user-generated advertisement).

User data store 407 can comprise data representative of users 430 including but not limited to user demographic data, user affinity data, frequency of advertisement data, and payment history to users.

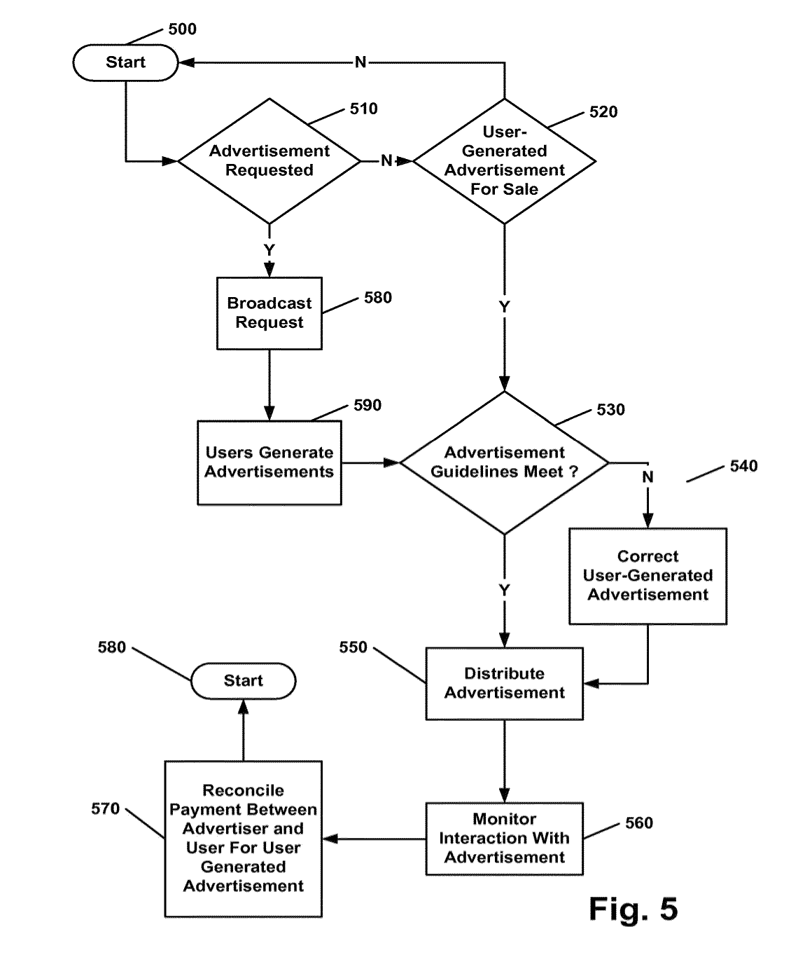

FIG. 5 shows exemplary processing performed when generating user-generated advertisements. As is shown in FIG. 5, processing begins at block 500 and proceeds to block 510 where a check is performed to determine whether a user-generated advertisement is being requested. If the check at block 510 indicates that an advertisement is not being requested, processing proceeds to block 520 where a check is performed to determine whether a user has a user-generated advertisement for sale (or distribution) to potential advertisers. If the check at block 520 indicates that there is user-generated advertisements for sale, processing proceeds to block 530 where a check is performed to determine whether the user-generated advertisement meets advertisement guidelines. If the check at block 530 indicates that the user-generated advertisement does not meet advertisement guidelines, processing proceeds to block 540 where the user is afforded the opportunity to bring the user-generated advertisement in line with the advertisement guidelines. Processing proceeds to block 550 where the advertisement is distributed for consumption by other participating users by one or more advertisers (e.g., such advertisers can be contacted by an exemplary advertisement services operator acting as a broker between users generating advertisements for products/services that users find interesting and advertisers who cooperate with the advertisement service operator to obtain new advertisements). From there, interaction with the user-generated advertisement is monitored at block 560 to determine the payment to be made to the user. Such payment can be based on one or more monetization guidelines. Processing then terminates at block 570.

However, if the check at block 530 indicates that the user-generated advertisement meets selected advertisement guidelines, processing proceeds to block 540 and continues from there. If the check at block 520 indicates that there is no user-generated advertisement for sale, processing reverts to block 500 and proceeds from there. If the check at block 510 indicates that a user-generated advertisement is being requested, processing proceeds to block 580 where a request is made to participating users to generate advertisements for a particular product/service for the requesting advertiser. The advertisement is then generated at block 590 by participating users for consumption by the advertisers and other participating users. From there processing proceeds to block 530 and continues from there.

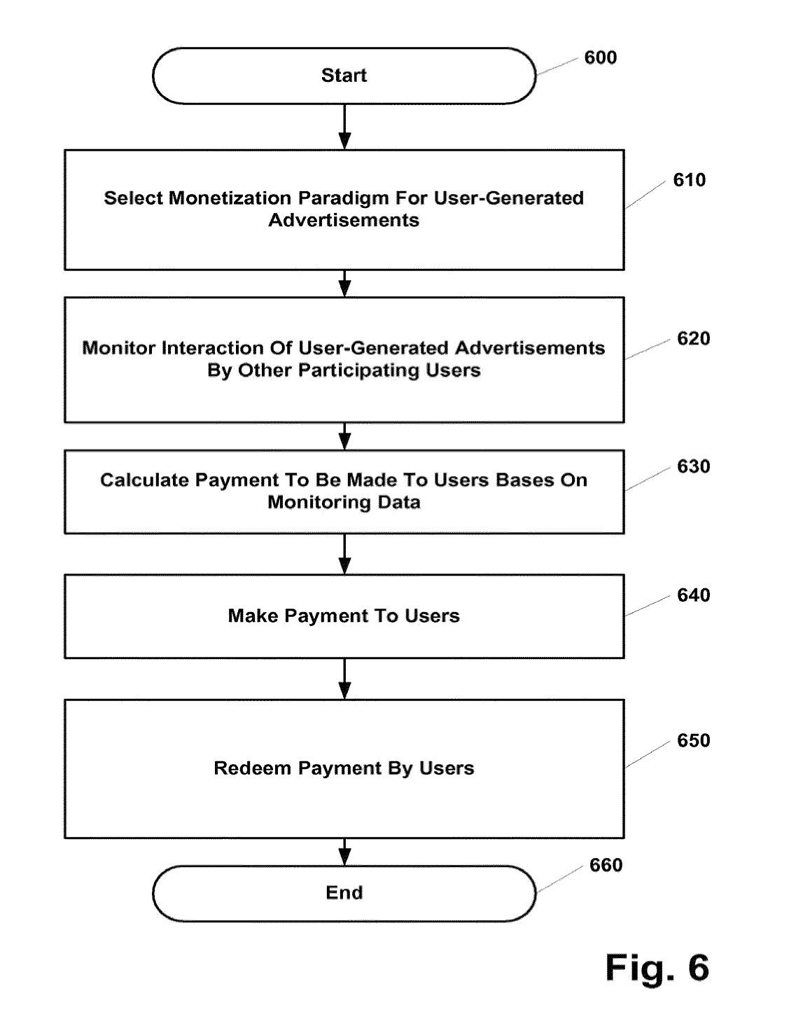

FIG. 6 describes the processing performed when processing payments to users generating user-generated advertisements. As is shown in FIG. 6, processing begins at block 600 and proceeds to block 610 where a monetization paradigm is selected. In an illustrative implementation the monetization paradigm can comprise a pure cash payment, a points based payment representative of a percentage value in a product/service which the user can purchase using accrued points, and a combination of cash and reward points. From there processing proceeds to block 620 where user-generated advertisements are monitored to determine how much interaction a given user-generated advertisement is receiving. Processing then proceeds to block 630 where a calculation is performed to calculate the payment to be made for users who have generated user-generated advertisements using the monitored interaction data. Processing then proceeds to block 640 where the payment is made to the participating users. The participating user can then redeem their payment (e.g., cash and/or reward points) with the advertisers at block 650. Processing then terminates at block 660.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both wired and wireless networked environments), partial computing environments, and other real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instruction sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A method to generate advertisements from participating users comprising:
receiving a user-generated advertisement from a first participating user;
determining whether the user-generated advertisement meets a selected one or more advertisement guidelines;
applying a selected one or more monetization paradigms to the user-generated advertisement if it is determined that the user-generated advertisement meets the selected one or more advertisement guidelines, each of the selected one or more monetization paradigms providing for at least one potential payment to the first participating user.

2. The method of claim 1, wherein applying a selected one or more monetization paradigms to the user-generated advertisement comprises:
calculating one or more payments due to the first participating user based on a selected one or more monetization paradigms.

3. The method of claim 2, wherein applying a selected one or more monetization paradigms to the user-generated advertisement further comprises:
distributing the user-generated advertisement; and
monitoring interaction of participating users with the user-generated advertisement.

4. The method of claim 3, wherein monitoring interaction of participating users with the user-generated advertisement comprises:
monitoring interaction of participating users, other than the first user, with the user-generated advertisement.

5. The method of claim 3, wherein calculating one or more payments due to the first participating user based on a selected one or more monetization paradigms further comprises:
calculating one or more payments due to the first participating user based on the monitored interaction of participating users with the user-generated advertisement.

6. The method of claim 1, further comprising:
receiving a request from a cooperating party for user-generated advertisements; and
communicating the request to participating users.

7. The method of claim 1, further comprising:
providing the first participating user with an opportunity to resubmit the user-generated advertisement if it is determined that the user-generated advertisement does not meet all of a selected one or more advertisement guidelines.

8. An advertisement system comprising:
a user-generated advertisement and monetization engine operable to receive user-generated advertisements from participating users; and
an instruction set comprising at least one instruction to direct the user-generated advertisement and monetization engine to facilitate the generation of the user-generated advertisements according to a selected one or more advertisement guidelines and to monetize the user-generated advertisements according to a selected one or more monetization paradigms.

9. The system of claim 8, wherein the user-generated advertisement and monetization engine further comprises a server computing environment that is adapted to communicate with a plurality of user computing environments over a communications network.

10. The system of claim 9, wherein the server computing environment comprises a user-generated advertisement data store capable of storing user-generated advertisements.

11. The system of claim 9, wherein the server computing environment further is adapted to communicate with at least one cooperating party computing environment over a communications network.

12. The system of claim 8, wherein the at least one instruction directs the user-generated advertisement and monetization engine to determine whether a first user-generated advertisement meets the selected one or more advertisement guidelines.

13. The system of claim 12, wherein the at least one instruction set directs the advertisement and monetization engine to distribute the first user-generated advertisement if the first user-generated advertisement meets the selected one or more advertisement guidelines.

14. The system of claim 13, wherein the at least one instruction set directs the advertisement and monetization engine to monitor interaction between participating users and the first user-generated advertisement.

15. The system of claim 8, wherein the at least one instruction set directs the advertisement and monetization engine to accept a request from a cooperating party for a user-generated advertisement and facilitates access to the request by participating users.

16. An advertisement system comprising:
an advertisement generation and monetization engine operating on an advertisement generation and monetization computing environment comprising a user-generated advertisement content data store, an advertisement guidelines data store, and a monetization guidelines data store;
a participating user interface, through which participating users can submit user-generated advertisements to the user-generated advertisement content data store;
wherein the advertisement generation and monetization engine includes an instruction set which comprises at least one instruction that directs an advertisement generation and monetization engine to determine whether a first user-generated advertisement stored on the user-generated advertisement content data store meets a selected one or more advertisement guidelines stored in the advertisement guidelines data store.

17. The system of claim 16, further comprising:
a cooperating party interface, through which cooperating parties can submit requests for user-generated advertisements to the advertisement generation and monetization platform.

18. The system of claim 17, wherein the participating user interface enables participating users to access requests for user-generated advertisements.

19. The system of claim 17, wherein the cooperating party interface comprises at least one cooperating party computing environment that can connect to the advertisement generation and monetization computing environment via a communications network and the participating user interface comprises at least one participating computing environment that can connect to the advertisement generation and monetization computing environment via the communications network.

20. The system of claim 16, wherein the advertisement generation and monetization engine includes an instruction set which comprises at least one instruction that directs an advertisement generation and monetization engine to reconcile payment to a participating user who submitted the first user-generated advertisement according to a selected one or more monetization paradigms stored in the monetization guidelines data store.
